(19) United States
(12) Patent Application Publication
(10) Pub. No.: US 2013/0216652 A1
(43) Pub. Date: Aug. 22, 2013

(54) INTRINSIC SUGAR REDUCTION OF JUICES AND READY TO DRINK PRODUCTS

(71) Applicants: Juan Sans-Valero, Colombus, OH (US); Pu-Sheng Cheng, Dublin, OH (US)

(72) Inventors: Juan Sans-Valero, Colombus, OH (US); Pu-Sheng Cheng, Dublin, OH (US)

(73) Assignee: NESTEC S.A., Vevey (CH)

(21) Appl. No.: 13/882,697

(22) PCT Filed: Nov. 3, 2011
(86) PCT No.: PCT/EP2011/069358

§ 371 Date: Apr. 30, 2013

(30) Foreign Application Priority Data
Nov. 3, 2010 (US) 61409792

(51) Int. Cl. A23L 2/84

(52) U.S. Cl. CPC A23L 2/84
USPC 426/51; 426/52; 426/658; 426/590; 426/599

(57) ABSTRACT

The invention relates to a method of reducing the intrinsic sugar content in a food product such as a juice or a ready to drink sugar based product, by contacting the food product with sufficient amounts of at least one transglycosidase under conditions sufficient to enzymatically convert intrinsic sugars in the food product to non-digestible carbohydrates and non-digestible oligosaccharides, such as fructo-oligosaccharides, and gluco-oligosaccharides to thus form a more nutritional product. The invention also relates to nutritional food products produced by the methods of the invention.

### FIELD OF THE INVENTION

The invention relates to a method of reducing intrinsic sugars in juice and ready-to-drink (RTD) sugar-containing products by converting the sugars therein to non-digestible carbohydrates and non-digestible oligosaccharides (NDOs) by in situ enzymatic reactions.

### BACKGROUND OF THE INVENTION

Recent studies have shown that high consumption of simple sugars have negative health effects. In response to these studies and the popularity of certain diets that emphasize the reduction of glycemic load, consumers demand lower glycemic index foods, which are less sugary and higher in soluble dietary fiber. To meet this demand, the food industry has given particular attention to a number of substitutes for the traditional sugary carbohydrates. These include non-nutritive sweeteners, sugar alcohols, isomalto-oligosaccharides, polyfructose polymers such as levan, fructo-oligosaccharides (FOSs), galacto-oligosaccharides and gluco-oligosaccharides. Particular interests have been directed to FOSs, and gluco-oligosaccharides.

FOSs impart mild sweetness, but also significantly, they are soluble dietary fibers with documented health benefits. FOSs are found naturally in, for example, banana, tomato, onion and numerous other plant sources. For commercial use, FOSs are produced enzymatically from sucrose using fructosyltransferase enzymes. FOSs are commercially available as a nutritional supplement and have Generally Recognized As Safe (GRAS) status. FOSs belong to the group of prebiotics because of their indigestibility nature. Prebiotics are defined as non-digestible food ingredients that beneficially affect the host by stimulating the growth and/or activity of beneficial bacteria in the colon.

Gluco-oligosaccharides are recognized as non-digestible oligosaccharides (NDOs) which are produced by enzymatic reaction of a glucosyltransferase. When a specific glucosyltransferase such a dextransucrase is used in the present of an acceptor such as maltose or glucose and sucrose as D-glucosyl donor, α-gluco-oligosaccharides are obtained, which in some cases contain α-1,2 and α-1,6 glucosidic bonds (Remaud-Simeon et al., 1994, Production and use of glucosyltransferases from Leuconostoc mesenteroides NRRL B-1299 for the synthesis of oligosaccharides containing α-1,2 linkages. Appl. Biochem Biotech 44:101-117). These α-gluco-oligosaccharides cannot be metabolized since they present high resistant to be attacked by the digestive enzymes in humans and animals. The prebiotic effect of the NDOs has also been demonstrated at the level of skin microbial flora.

The use of enzymes for the production of functional NDOs has been done industrially. Many products such as beverages, infant milk powders, confectionary, bakery products, yogurts and dairy desserts now contain added NDOs for their functional benefits, such as increasing the number of friendly bacteria in the colon while simultaneously reducing the population of harmful bacteria.

FOSs can be manufactured by two different enzymatic processes, i.e., enzymatic treatment of sucrose (Meji Seika Kaisha, Tokyo, Japan) and enzymatic hydrolysis of inulin (Orafti, Belgium). Gluco-oligosaccharides were initially developed as low-calorie bulking agents, to be used in food formulations in complement of intense sweeteners. These oligosaccharides are currently marketed for human nutritional application as food complements, in combination with specific microbial flora and vitamins.

Glucosyltransferases can be used to catalyze the transfer of glucosyl residues from a donor molecule to a particular acceptor (Rabelo et al., 2006, Enzymatic Synthesis of Prebiotic Oligosaccharides, Appl. Biotechnol. Biochem. 133, 31-40; Rodrigues et al., 2005, The Effect of Maltose on Dextran Yield and Molecular Weight Distribution, Bioprocess Biosyst. Eng. 28, 9-14; Rodrigues et al., 2006, Optimizing Panose Production by Modeling and Simulation Using Factorial Design and Surface Response Analysis, J. Food Eng. 75, 433-440; Monsan and Paul, 1995, Enzymatic Synthesis of Oligosaccharides, FEMS Microbiol. Rev. 16, 187-192). Dextransucrase is a bacterial extracellular glucosyltransferase produced by Leuconostoc strains that promotes dextran synthesis. Fructose is a natural side product released when the enzyme polymerizes glucose from sucrose into dextran. The same enzyme is also responsible for the synthesis of prebiotic oligosaccharides through the acceptor reaction. In the presence of sucrose the introduction of other carbohydates (acceptors) shifts the enzyme pathway from dextran synthesis toward the production of oligosaccharides (Rabelo et al., 2006, Enzymatic Synthesis of Prebiotic Oligosaccharides, Appl. Biotechnol. Biochem. 133, 31-40). This shifted pathway has been called acceptor reaction. Besides Leuconostoc strains, dextransucrase can be also obtained from other types of lactic bacteria—Streptococcus and Lactobacillus.

Although oligosaccharides are usually added as functional food additives to different products after being enzymatically produced from pure sugars, some recent reports propose to enzymatically produce oligosaccharides using sugars already present in the food products. For example, US patent application publication no. 2009/0297660 discloses producing galacto-oligosaccharides in cream cheese products by using the lactose contained in the dairy substrate. US patent application publication no. 2010/0040728 relates to in situ reduction of sucrose in beverages by converting sucrose to FOS. Also, European patent EP 0458358 B1 discloses a process for producing skim milk powder containing high galacto-oligosaccharides content using the lactose present in milk as substrate by contacting concentrated milk with beta-galactosidase.

However, there is still a need in the industry to more efficiently convert intrinsic sugars in food products such as juices and other RTD products to oligosaccharides in order to provide nutritional and health benefits in the resulting products. The invention now satisfies this need of the industry.

### SUMMARY OF THE INVENTION

The invention provides a method of reducing intrinsic sugar content of a food product by contacting the food product with a sufficient amount of at least one transglycosidase under conditions sufficient to enzymatically convert intrinsic sugars in the food product to non-digestible oligosaccharides, thus reducing intrinsic sugar content of the food product and forming a more nutritional food product. Preferably, the at least one transglycosidase comprises a glucosyltransferase. More preferably, the method of the invention further comprises further reducing the intrinsic sugar content of the food product by contacting the food product with a sufficient amount of a fructosyltransferase under conditions sufficient to enzymatically convert further intrinsic sugars in the food product to non-digestible oligosaccharides.

In some preferred embodiments, the fructosyltransferase and the glucosyltransferase may contact the food product simultaneously. In other preferred embodiments, the fructosyltransferase and the glucosyltransferase may contact the food product sequentially by forming a reduced sucrose food product by first contacting the food product with a sufficient amount of the fructosyltransferase under conditions sufficient to enzymatically convert at least some of the intrinsic sugars in the food product to non-digestible fructo-oligosaccharides while also forming glucose; and then contacting the reduced sucrose food product with a sufficient amount of the glucosyltransferase under conditions sufficient to enzymatically produce glucooligosaccharides while reducing glucose and further reducing sucrose therein, thus reducing the intrinsic sugar content of the resulting food product. In other preferred embodiments, the fructosyltransferase and the glucosyltransferase may contact the food product sequentially by forming a reduced sucrose food product by first contacting the food product with a sufficient amount of the glucosyltransferase under conditions sufficient to enzymatically convert at least some of the intrinsic sugars in the food product to gluco-oligosaccharides while reducing glucose and sucrose therein; and then contacting the reduced sucrose food product with a sufficient amount of the fructosyltransferase under conditions sufficient to enzymatically convert at least some of the intrinsic sugars in the food product to non-digestible fructo-oligosaccharides while also forming glucose, thus reducing the intrinsic sugar content of the resulting food product.

In a preferred embodiment, the method of the invention may further comprise terminating the first enzymatic reaction, i.e. the fructosyltransferase enzymatic reaction, or the glucosyltransferase enzymatic reaction, by applying heat or conducting pasteurization before contacting the food product with the second enzyme, i.e. glucosyltransferase, or fructosyltransferase respectively. Preferably, the method further comprises terminating the second enzymatic reaction, i.e. the glucosyltransferase enzymatic reaction, or the fructosyltransferase enzymatic reaction respectively, after the nutritional food product is obtained. In another preferred embodiment, the enzymes are immobilized on a support prior to the contacting steps such that the enzymatic reaction can be terminated by removing the immobilized enzymes from contact with the food product.

Preferably, the glucosyltransferase is a dextransucrase derived from a strain of lactic bacteria, and the fructosyltransferase is derived from a plant or microbial source.

In another preferred embodiment, the method of the invention further comprises contacting the food product with a levansucrase to produce non-digestible carbohydrates in the food product.

A typical food product is a RTD product or a juice that contains sugar. The juice can be a fruit juice such as orange juice, peach juice or mango juice, or a juice concentrate.

In a preferred embodiment of the method of the invention, the food product is a sucrose or sucrose and glucose containing fruit juice or RTD product, and the enzymes are a fructosyltransferase and a glucosyltransferase, preferably a dextransucrase. Although both enzymes can contact the juice simultaneously, it is preferred that the sucrose and glucose containing product first contacts the fructosyltransferase to produce FOSs, and then the glucosyltransferase to produce gluco-oligosaccharides. In these embodiments of the method of the invention, the sucrose content of the food product can be reduced by at least 10%, and preferably by at least 40%, after exposure to dextransucrase exposure, or at least 30%, and preferably at least 70%, after exposure to both fructosyltransferase and dextransucrase, as compared to a corresponding RTD product or juice which is not subjected to such exposure. In these embodiments of the method of the invention, the sugar conversion to non-digestible oligosaccharides is at least 10% after exposure to fructosyltransferase and dextransucrase as compared to a corresponding juice or RTD drink which is not subjected to such exposure. In these embodiments of the method of the invention, the nutritional food product, especially a fruit juice, contains at least 10% non-digestible oligosaccharides based on the dry weight of the food product, after exposure to fructosyltransferase and dextransucrase.

Also provided are the nutritional food products that are produced by the methods of the invention, such as a juice, preferably a fruit juice, most preferably an orange juice, peach juice or mango juice, or a RTD product, having a reduced intrinsic sugar level with increase of NDOs content.

The invention also relates to the use of fructosyltransferase and glucosyltransferase either simultaneously or sequentially to enzymatically convert intrinsic sugars in a food product to non-digestible oligosaccharides to reduce the intrinsic sugar content of the food product and form a more nutritional food product.

### BRIEF DESCRIPTION OF THE DRAWINGS

FIG. 1 shows an HPLC chromatogram from glucooligosaccharides (GOS) formation with dextransucrase in orange juice concentrate (OJC) by using a HPAEC Dionex system. A: Sugar content in OJC before enzymatic reaction. B: Sugar content in OJC after enzymatic reaction. Peaks: 1=glucose; 2=fructose; 3=sucrose.

FIG. 2 shows an HPLC chromatogram showing fructooligosaccharides (FOS) and glucooligosaccharides (GOS) formation before and after enzymatic reaction with fructosyltransferase and dextransucrase in a model solution of example 4. A: Sugar content in the model solution before enzymatic reaction. B: Sugar content in the model solution after enzymatic reaction. Peaks: 1=glucose; 2=fructose; 3=sucrose.

FIG. 3 shows an HPLC chromatogram showing fructooligosaccharides (FOS) formation after enzymatic reaction with fructosyltransferase in orange juice concentrate (OJC) by using a refractive index detector.

### DETAILED DESCRIPTION OF THE INVENTION

The following definitions are used in this disclosure:

The singular forms “a”, “an”, and “the” include plural referents unless the context clearly dictates otherwise.

Unless the context clearly requires otherwise, throughout the specification, the words “comprise”, “comprising” and the like are to be construed in an inclusive sense as opposed to an exclusive or exhaustive sense; that is to say, in the sense of “including, but not limited to”.

The word “about”, as used in the specification, should generally be understood to refer to both numbers in a range of numerals. Moreover, all numerical ranges herein should be understood to include each whole integer within the range.

Unless noted otherwise in the specification, all percentages refer to dry weight percents.

The term “sucrose” means a disaccharide comprised of 1 mole of D-glucose and 1 mole of D-fructose wherein the C-1 carbon atom of the glucose and the C-2 carbon atom of the fructose participate in the glycoside linkage.

The term “endogenous” as used herein with reference to sucrose or fiber refers to sucrose or fiber that is naturally contained in a food product (native sucrose or fiber).

The term “disaccharide” as used herein refers to any compound that comprises two covalently linked monosaccharide units. The term encompasses but is not limited to such compounds as sucrose, lactose and maltose.

The term “oligosaccharide” as used herein refers to a compound having 2 to 10 monosaccharide units joined by glycosidic linkages.

As used herein the term “dextrose” is used interchangeably with the term “glucose”.

The term “fructo-oligosaccharides” (FOS) means short chain oligosaccharides comprised of D-fructose and D-glucose units. Some preferred FOSs are short chain molecules with no more than 6 fructose residues. For example some preferred FOSs comprise of one molecule of D-glucose in the terminal position and from 2 to 4 D-fructose units having the structural formula below wherein n=2-4 fructose residues. The linkage between fructose residues in FOSs are a beta-(2-1) glycosidic links.

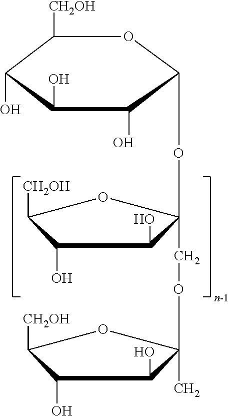

The term “fructosyltransferase (FT)” means enzymes having fructose transferase activity, which are capable of producing fructo-oligosaccharides in the presence of sucrose. Enzymes having fructose transferase activity have been classified as E.C. 2.4.1.99 (sucrose:sucrose fructosyltransferases) and E.C. 3.2.1.26 (beta-D-fructofuranosidases or beta-fructosidases).

The term “gluco-oligosaccharides” (GOS) means short chain molecules with 2 to 10 glucose residues. The linkage between glucose residues in gluco-oligosaccharides are α-1,2 and α-1,6 glucosidic bonds.

The term “dextransucrase” means enzymes having glucose transferase activity, which are capable of producing dextran in the presence of sucrose and prebiotic oligosaccharides in the presence of an acceptor such as glucose and maltose among others. Enzymes having glucose transferase activity have been classified as E.C. 2.4.1.5.

The term “transglycosidase” means enzymes that catalyze the transfer of a glycosyl donor to an acceptor molecule forming a new glycosidic bond region- and stereo-specifically. Enzymes having glycosidic transfer activity have been classified as E.C. 2.4.

The term “non-digestible carbohydrate” means long chain molecules with more than 10 monosaccharide units which could consist of hundreds or thousands units that resist hydrolysis of digestive enzymes. Levan is a non-digestible carbohydrate recognized as fructan that comprise predominantly β-2,6 glycosidic bonds between adjacent fructose units.

The term “non-digestible oligosaccharides (NDOs)” means short chain molecules with 2 to 10 monosaccharide units that resist hydrolysis of digestive enzymes, but are preferentially utilized in the colon by Bifidobacteria and/or lactobacilli.

The term “food product” is broadly defined as a food or beverage which is consumable and includes sucrose or sucrose and glucose among other possible sugars.

The term “RTD product” refers to a beverage product which is consumable and includes sucrose or sucrose and glucose among other possible sugars.

A “corresponding food product” refers to a food product that has not been contacted with a transglycosidase according to the process of the invention, but has otherwise been exposed to essentially the same conditions as a subject food product contacted with a transglycosidase according to the process of the invention.

“In situ” refers to a process wherein transglycosidase is directly contacted with a food product.

The term “contacting” refers to directly exposing a food product to a transglycosidase.

The term “substantially all converted” refers to maintenance of a low sucrose concentration in the food product.

The phrase “low sucrose concentration” or “reducing the sucrose concentration” refers to a concentration level of sucrose in a food product that is less than the concentration level of sucrose in a corresponding food product, which has not been contacted with transglycosidase according to the methods of the invention. In some embodiments, a low sucrose concentration means essentially complete removal of the sucrose in the food product.

The term “enzymatic conversion” refers to the modification of a carbon substrate to an intermediate or the modification of the intermediate to an end product by contacting the substrate or intermediate with an enzyme.

The phrase “FOS producing reaction” means the process of contacting a food product with a fructosyltransferase to enzymatically convert sucrose to FOSs.

The phrase “a high-NDOs food product” means a food product in which the level of NDOs is elevated over the endogenous NDOs level in the corresponding food product and obtained by the in situ process encompasses by the invention.

A “glucose isomerase” (e.g., EC 5.3.1) refers to an enzyme that isomerizes glucose, to fructose (e.g. EC 5.3.1.9).

A “glucose oxidase” (e.g., EC 1.1.3.4) refers to an enzyme that catalyzes the reaction between glucose and oxygen producing gluconate and hydrogen peroxide.

A “levansucrase” (E.C. 2.4.1.10) refers to an enzyme that catalyzes a fructosyl transfer from sucrose to a various acceptor molecules producing mainly levan which consists of D-fructofuranosyl residues linked predominantly by β-2,6 limkage as the main chain with some β-2,1 branching points.

An “enzyme unit” for FT is defined as the amount of enzyme responsible for transferring one micromole of fructose per minute under standard conditions or as the amount of enzyme for producing one micromole of glucose under standard conditions.

An “enzyme unit” for dextransucrase is defined as the amount of enzyme responsible for releasing one micromole of reducing sugar per minute under standard conditions.

The term “ATCC” refers to American Type Culture Collection located at Manassas, Va. 20108.

The invention provides a method of reducing intrinsic sugar content in juices and RTD products. Different types of enzymes, mainly transglycosidases, are used to convert the sucrose and glucose present in juices and RTD products into non-digestible carbohydrates and non-digestible prebiotic oligosaccharides, such as gluco-oligosaccharides, and fructo-oligosaccharides (FOSs).

Fructosyltransferases (FT) useful for the practice of the invention are classified as EC.2.4.1.99 and exhibit transferase activity. Such enzymes are sometimes also called beta-fructofuranosidase. Beta-fructofuranosidase also include hydrolytic enzymes classified as EC. 3.2.1.26. The term FT as used herein applies to any enzyme capable of catalyzing the transfer reaction and the use of this term in no way restricts the scope of the invention.

Fructosyltransferases used in the invention may be derived from plant sources such as asparagus, sugar beet, onions, Jerusalem artichokes and others (See, Henry, R. J. et al., (1980) Phytochem. 19: 1017-1020; Unger, C. (1994) Plant Physiol. 104: 1351-1357; and Luscher, M. et al., (2000) Plant Physiol. 124:1217-1228).

Fructosyltransferase may also be derived from fungal sources, such as Aspergillus, Aureobasidium and Fusarium. More specific examples include Aspergillus japonicus, such as CCRC 38011; Aspergillus niger, such as ATCC 20611; Aspergillus foetidus (such as NRRL 337); Aspergillus aculeatus; Aureobasidium pullulans, such as ATCC 9348, ATCC 12535; and ATCC 15223 (See, Yuan-Chi Su et al., (1993) Proceedings National Science Council, ROC 17:62-69; Hirayama, M. et al., (1989) Agric. Bioi. Chem. 53: 667-673; Hidaka, H., et al., (1988) Agric. Bioi. Chem. 52:1181-1187; Boddy, L. M. et al., (1993) Curro Genet. 24:60-66; and U.S. Pat. No. 4,276,379).

Fructosyltransferases additionally may be derived from bacterial sources, such as Arthrobacter (Fouet, A. (1986) Gene 45:221-225; Sato, Y. et al. (1989) Infect. Immun. 56:1956-1960; and Aslanidis, C. et al., (1989) J. Bacteriol., 171: 6753-6763).

In some instances, the fructosyltransferase may be a variant of a naturally occurring fructosyltransferase. Reference is made to U.S. Pat. No. 6,566,111, wherein a β-fructofuranosidase was genetically engineered to improve the productivity of the enzyme (see also US Patent Application Publication No. 20020192771 to Koji Y., et al.).

Fructosyltransferase may be obtained as one of the enzymes present in the commercial enzyme preparations such as PECTINEX ULTRA SP-L (Novozymes AlS) and RAPIDASE TF (DSM).

Dextransucrase promotes dextran synthesis as well as the synthesis of prebiotic oligosaccharides through the acceptor reaction (Rodrigues et al., 2003, 2006; Rabelo et al., 2006; Monchois et al., 1999; Monsan and Paul, 1995). In the presence of sucrose, the introduction of other carbohydrates (acceptors) shifts the enzyme pathway from dextran synthesis toward the production of oligosaccharides (Tsuchiya et al., 1952; Pereira et al., 1998; Heincke et al., 1999; Rodrigues et al., 2006; Rabelo et al., 2006). This shifted pathway has been called acceptor reaction, and the acceptor products are oligosaccharides, i.e., gluco-oligosaccharides, with degree of polymerization between 2 and 10, which are considered prebiotic carbohydrates (Chung and Day, 2002, 2004).

The dextransucrase used in the method of the present invention can be prepared from Leuconostoc strains such as mesenteroides or citreum as reported in the literature (Monsan and Paul, 1995; Rodrigues et al., 2005, 2006; Rabelo et al., 2006). For example, dextransucrase from Leuconostoc mesenteroides NRRL B-512F was obtained from Sigma. Besides Leuconostoc strains, dextransucrase can be also obtained from other types of lactic bacteria—Streptococcus and Lactobacillus.

In one embodiment of the method of the invention, the intrinsic sugar content in juices is reduced by the production of non-digestible fructo-oligosaccharides. FOSs are produced from the sucrose present in the juice by the transfructosylation activity of the enzyme fructosyltransferase. The FOSs formed in this process contain one unit of glucose and a number of fructose units between 1 and 3 with a linkage β (1-2). At the same time, glucose and a small amount of fructose are formed from sucrose as by-products in the hydrolysis reaction of the same enzyme.

In another embodiment of the method of the invention, the intrinsic sugar content in juices or RTD products is reduced by the production of non-digestible gluco-oligosaccharides. Dextransucrase is a glucosyltransferase enzyme that promotes dextran synthesis. Fructose is released as a side product when the enzyme polymerizes glucose from sucrose in juice. In the presence of sucrose, the introduction of other carbohydrate acceptor, such as the glucose present in juice, shifts the enzyme pathway from dextran synthesis towards the formation of gluco-oliogsaccharides. Using dextransucrase, the intrinsic sucrose and glucose concentration in juice are reduced.

In a more preferred embodiment of the method of the invention, the intrinsic sugar content in juices or RTD products is reduced by treatment to produce both fructo-oligosaccharides and gluco-oligosaccharides. The enzyme fructosyltransferase is first applied to produce FOS with subsequent sucrose reduction and glucose formation in a juice or RTD product. When FOS production reached its maximum, the reaction is stopped at such point in which the sucrose concentration is substantially lower than the glucose concentration in the juice or RTD product. Then, the enzyme dextransucrase is applied to produce gluco-oligosaccharides, further reducing sucrose as well as the glucose concentration. By using both fructosyltransferase and dextransucrase, the total sugar content, can be reduced to the lowest caloric level, and the highest level of oligosaccharide, as compared to the corresponding food product or using either enzyme alone.

It is also possible to further contact the food product with a levansucrase to produce levan in the food product.

The food products can be treated in a number of ways. Contact with a transglycosidase is performed as follows:

In particular, fructosyltransferase is first applied. The fructosyltransferase may be used in a soluble form or the enzyme may be immobilized by any number of techniques known in the art and these include adsorption on a carrier, as described for example in WO 02083741A (See, Hayashi et al., 1991 J. Ferment. Bioeng. 72:68-70 and Hayashi et al., (1991) Biotechnol. Letts 13:395-398) or other known techniques. Immobilization of the enzyme may allow for the economic use of high enzyme dosage and eliminates or reduces the need for removal or inactivation of residual enzyme from the product. Soluble enzymes may be optionally inactivated by pasteurization or other known methods. The amount of fructosyltransferase used in the process according to the present invention will vary depending on a number of variables. These variables include but are not limited to, the food product used in the invention process; the amount of FOS to be produced; and the treatment time. One of skill in the art will readily be able to determine the amount of fructosyltransferase to be used in the process

Additionally as known in the art, enzyme dose and reaction time are inversely proportional, and therefore it is useful to calculate the product of dose and reaction time as a measure of the degree of reaction. For example, two hours at a dose of one unit per gram of sucrose (dose×time=2 U·hrs/g) is about equal to one hour of reaction at a dose of 2 U/g (also 2 U·hrs/g). In some embodiments, a dose time of about 0.5 U·hrs/g to 400 U·hrs/g will be required to convert sucrose to FOS. In other embodiments the dose time will be about 0.5 U·hrs/g to 200 U·hrs/g; also about 1 U·hrs/g to 100 U·hrs/g; and further about 1 U·hrs/g to 50 U·hrs/g.

While under some conditions a low dose time may be required (e.g. around 1 to 2 U·hrs/g) under other conditions a greater dose time may be required to provide the same degree of conversion. For example, when the pH of the food product is acidic, the fructosyltransferase may be less active and a greater dose time will be required. In some non limiting examples a dose time of about 200 U·hrs/g to or greater may be required for the enzymatic conversion by a fructosyltransferase process under acidic conditions.

In some embodiments, the FOS producing reaction will proceed under a large range of temperature conditions, and this may be a function of time. In some embodiments, the temperature range is about −10° C. to 95° C., about −5° C. to 90° C., about 1° C. to 80° C., about 1° C. to 75° C.; about 1° C. to 70° C.; about 5° C. to 65° C., about 5° C. to 60° C., about 5° C. to 55° C., about 10° C. to 50° C.; about 5° C. to 40° C.; and about 10° C. to 40° C. In other embodiment, the temperature range will be about −10° C. to about 10° C. In other embodiments, the FOS producing reaction will proceed under pH conditions in the range of about pH 3 to 8; about pH 3 to 7; about pH 3 to 6 and about pH 3.5 to 6. In some embodiments, the FOS producing reaction will proceed under pH conditions of about pH 3 to 4.5 for orange juice and apple juice and also about pH 5.5 to 7.5 for maple syrup.

The contacting can proceed for as little as 1 minute or for as long as several days or weeks. In some embodiments the contacting will occur for 30 minutes to 48 hours. In other embodiments, the contacting may continue during the shipping and storage of the food product prior to consumption. Generally the sucrose is enzymatically converted to FOS in about 1 minute to 60 hours.

In some embodiments, the suitable contacting conditions may be different from the conditions considered optimum for enzyme activity, particularly to maintain organoleptic qualities, and it may be necessary to adjust time of contacting and fructosyltransferase enzyme dosage. As one non-limiting example, the activity of a fructosyltransferase that has an optimum at about pH 5.5 and about 60° C., will be slowed when contacted with a fruit beverage at about pH 3.6 and about 5° C., so as to essentially maintain the quality of the food product, which includes, e.g., texture, taste, color and odor. Time of contacting and enzyme dosage adjustments are within the skill of one in the art.

Methods well known in the art are available for determining the level of FOS in a food product. A direct method of measuring FOS is by HPLC (Yun J. W. et al., (1993). Korean J. Biotechnol. Bioeng. 9:35-39). Other methods include chromatography and NMR. In the absence of a hydrolytic reaction, the formation of each FOS bonds leads to the release of a glucose molecule which may be measured by a wide variety of method including the glucose oxidase based blood glucose test strips.

When FOS production reached its maximum, the reaction may be terminated by conditions leading to denaturation of the fructosyltransferase, such as heat or pasteurization or by physically removing the enzyme in the case of immobilized fructosyltransferase.

Thereafter or simultaneously, dextransucrase is applied to provide significantly increased gluco-oligosaccharides content. The mixture of the food product and the dextransucrase is held for a time and at a temperature effective to convert at least about 30 percent of the sucrose present in the food product, such as about 0.25 to about 72 hours at about 20 to about 40° C., preferably for about 0.5 to about 16 hours at about 30 to about 40° C., although the precise conditions should be selected based on the optimum conditions for the particular dextransucrase enzyme or combination of enzymes used. In some embodiments, the gluco-oligosaccharide producing reaction will proceed under a large range of temperature conditions, and this may be a function of time. In some embodiments, the temperature range is about −10° C. to 95° C., about −5° C. to 90° C., about 1° C. to 80° C., about 1° C. to 75° C.; about 1° C. to 70° C.; about 5° C. to 65° C., about 5° C. to 60° C., about 5° C. to 55° C., about 10° C. to 50° C.; about 5° C. to 40° C.; and about 10° C. to 40° C. In other embodiment, the temperature range will be about −10° C. to about 10° C. The gluco-oligosaccharides produced are characterized by methods known to a person of ordinary skills in the art, for example, by detecting its degree of polymerization with Thin Layer Chromatography (TLC) on Whatman K6 silica plates, 250-lm thickness (Whatman, Kent, UK) or by HPLC analysis.

The amount of dextransucrase used in the process according to the present invention will vary depending on a number of variables. These variables include but are not limited to, the food product used in the invention process; the amount of gluco-oligosaccharides to be produced; the treatment time; and other process conditions. One of skill in the art will readily be able to determine the amount of dextransucrase to be used in the process according to the invention. When the food product is a juice for consumption, it is generally subjected to pasteurization treatment. In some cases, this treatment may be from about 15 seconds to 60 minutes, 15 seconds to 30 minutes, 5 minutes to 25 minutes and also 10 minutes to 20 minutes at a temperature of about 60° C. to 95° C. and generally at a temperature of about 65° C. to 75° C.

Alternatively, dextransucrase is first applied to the food product, followed by fructosyltransferase, to provide a food product with an intrinsic sugar content reduced when compared with the untreated food product. In this case, dextransucrase may be inactivated before application of fructosyltransferase, for instance by pasteurization or other known methods.

As mentioned above, in embodiments of the method of the invention, the enzyme(s) may be immobilized before contacting the food product. In particular, it may be useful to immobilize fructosyltransferase, and where the case may be, dextransucrase. The most common immobilization techniques are as follows

Covalent binding: In this method, enzymes are covalently linked to a support through the functional groups in the enzymes that are not essential for the catalytic activity. Oxides materials such as alumina, silica, and silicated alumina can be used for covalent binding of fructosyltransferase and dextransucrase.

Entrapment: The entrapment method is based on the localization of an enzyme within the lattice of a polymer matrix or membrane. Entrapment methods are classified into five major types: lattice, microcapsule, liposome, membrane, and reverse micelle. The enzyme is entrapped in the matrix of various synthetic or natural polymers. Alginate, a naturally occurring polysaccharide that forms gels by ionotropic gelation is the most popular one (Mammarella et al., 2005). Also, alginate as an immobilization matrix was used in combination with gelatin to immobilize the enzymes, i.e., fructosyltransferase and dextransucrase in fibers.

Physical adsorption: Physical adsorption is the simplest and the oldest method of immobilizing enzymes onto carriers. Immobilization by adsorption is based on the physical interactions between the enzymes and the carrier, such as hydrogen bonding, hydrophobic interactions, van der Waals force, and their combinations. Furthermore, adsorption is cheap, early carried out, and tends to be less disruptive to the enzymes than chemical means of attachment.

Cross-linking: The cross-linking method utilizes a bi- or multifunctional compounds, which serve as the reagent for intermolecular cross-linking of the enzymes. Cross-linking may be used in combination with other immobilization method, mainly with adsorption and entrapment. (Grosova et al., 2008).

Cotton has a high mechanical strength due to its crystalline cellulosic structure. The strength allows the porosity associated with fibrous structure to be maintained even at a high packing density. The cellulosic nature of cotton also possesses the desirable characteristics of stability for chemical, biochemical and physical attacks. Compared with commonly used materials, cotton fiber is widely available and relatively inexpensive, which makes the material ideal for immobilization of enzymes.

Further details can be found in the examples that follow herein.

The invention also provides a nutritional food product by using the method of the invention, which significantly reduces the total free sugars and, as a result, the total caloric content. The food product of the invention will also contain oligosaccharides which are prebiotics and can provide the benefits associated with them, such as selectively stimulate the growth of probiotic bacteria in the colon. In particular, the stimulation of the intestinal microflora by oligosaccharides has been shown to relieve constipation, to improve blood lipid composition, and to enhance calcium and magnesium absorption. Furthermore, consumption of oligosaccharides has also been shown to reduce detrimental colon bacteria, to regulate cholesterol and blood pressure, and thus may reduce the risk of colon cancer.

The food product is preferably a beverage such as a sweet beverage or an RTD product, or a sweetener such as a syrup. Preferred sweet beverages include fruit juices such as, orange, mango, peach, apple, grapefruit, grape, pineapple, cranberry, lemon, prune and lime juices. Particularly preferred beverages are orange, mango and peach fruit juices.

Using orange juice as one specific example, the enzymatic reactions can be conducted at a solids level ranging from natural juice (e.g., about 12% w/v solids or less, such as less than 10%, less than 8% or less than 6%) to concentrated juice (e.g., about 40% w/v solids or higher, such as greater than 45%, greater than 50%, greater than 55% or greater than 65%).

The initial sucrose and glucose level will vary with the type of food product. In some embodiments, the % sucrose (w/v) in the food product will be about between 2% and 75%, also between 10% and 55%, between 25% and 55% and further between 30 and 45%. In other embodiments, the sucrose level in orange juice may be about 2 to 12%, such as 4 to 10%, while the initial sucrose level in concentrated orange juice may be about 20 to 50%, such as 25 to 40%. In other embodiments, the % glucose (w/v) in the food product will be about 2% to 75%.

The fructosyltransferase enzymatically converts sucrose into a FOS. A FOS containing 2 fructose residues is abbreviated GF2 (G is for glucose and F is for fructose). A FOS containing 3 fructose resides is abbreviated GF3 and those having 4 fructose residues are abbreviated GF4. GF2 is also known as 1-kestose, GF3 is also known as nystose. In some embodiments, the FOS level in the food product will be increased by at least 0.5%, 1%, 5%, 10%, 15%, 20%, 25%, 30%, 40%, 50%, 75%, 80%, 85%, 90%, 95%, 100%, 200%, 300% and greater as compared to the corresponding food product. However, typically, a corresponding food product essentially does not contain FOSs or contains less than 1% (e.g., between 0 to 1% and 0 to 0.5%) FOSs. In some embodiments, at least 20%, 25%, 30%, 40%, 45%, 50%, 55% and 60% of the FOS produced in the food product comprises GF2. In some embodiments, the increase in the FOS level take place between 15 minutes to 62 hours (e.g., between 15 minutes and 48 hours, between 15 minutes and 36 hours, and between 30 minutes and 24 hours).

In other embodiments, between 100% and 20% of the sucrose in the food product will be enzymatically converted to FOS by the process of the invention. In some embodiments, at least 40%, at least 50%, at least 60%, and also at least 70% of the sucrose in the food-product will be converted to FOS by the process according to the invention. In some embodiments, the enzymatic conversion of sucrose to FOS will occur in the range of between 15 minutes to 62 hours (e.g., between 15 minutes and 48 hours, between 15 minutes and 36 hours and between 30 minutes and 24 hours).

In some embodiments, the sucrose level in the food product may be reduced by at least 5%, 10%, 15%, 20%, 25%, 30%, 35%, 40%, 45%, 50%, 55%, 60%, 65%, 70%, 75%, 80%, 85%, 90%, and 95% as compared to the corresponding food product. In some embodiments, the amount of sucrose will be reduced by more than 50%, and in other embodiments, the amount of sucrose will be reduced by more than 90% as compared to the corresponding food product. In some embodiments, the food product produced by a process of the invention will include about 0.5%, 1%, 2%, 5%, 10%, 20%, 30%, 40%, 50%, 60%, 70%, 80%, 90% sucrose. In other embodiments, a method encompassed by the invention produces a food product with a dextrose (glucose) level that is at least 25%, 50%, 75%, 100%, 125% or greater than the dextrose level of the corresponding food product. In some embodiments, the glucose level of a food product contacted with a fructosyltransferase according to the invention will be between 0.1 to 20% w/v (weight/volume). In some embodiments, the amount of fructose produced in the food product will be less than 5%, less than 2%, less than 1% and also in some embodiments less than 0.5%. In some embodiments, the production of FOS according to the methods of the invention is stable meaning that there is essentially no reversion of naturally occurring sucrose. In some embodiments, FOS, which is produced according to methods of the invention is not substantially hydrolyzed to yield glucose and fructose. In some embodiments, the in situ FOS formation may be directly correlated with dextrose production.

In some embodiments, the glucose level in the food product may be reduced by at least 5%, 10%, 15%, 20%, 25%, 30%, 35%, 40%, 45%, 50%, 55%, 60%, 65%, 70%, 75%, 80%, 85%, 90%, and 95% as compared to the corresponding food product after contacted with dextransucrase.

In some food products, the reduced intrinsic sugar content may affect the taste of the product that consumers would otherwise expect. In some situations, to provide added sweetness, a natural or artificial sweetener can be added. Typical sweeteners for this purpose include a natural sweetener such as stevia is preferred but other natural and artificial sweeteners (e.g., sucralose) that are generally known to skilled artisans can be used. Of course, the final taste characteristics of any particular food product can be altered as desired by routine testing using such sweeteners or other conventional additives.

### EXAMPLES

The invention is described in some detail below for purposes of clarity and understanding. The following examples are intended to illustrate the preferred embodiments of the invention without limiting the scope as a result. It will be appreciated by one skilled in the art, from a reading of the disclosure, that various changes in form and detail can be made without departing from the true scope of the invention in the appended claims.

### Example 1

### Sucrose Reduction in Model Solution by Using Dextransucrase

The sucrose reduction was studied in model solution with the same sugar ratio and concentration of sugars present in orange juice concentrate. The sugar solution was treated with 0.014% (w/w) dextransucrase from Leuconostoc mesenteroides B-512F (Sigma, Franklinton NC) for 28 h. The reaction was carried out at 30° C. and the pH was adjusted to 5.2. Samples were drawn at appropriate time intervals and heated at 90° C. during 5-10 min to stop the enzyme activity. The residual sucrose content was analyzed by HPLC with a pump (Agilent 1100 Series) coupled to a carbohydrate column (Shodex amino column Ashipak NH2P-50 4E). A refractive index detector was used. The mobile phase was 75% (v/v) acetonitrile. The concentration of sucrose was determined from peak areas by using standards of this sugar. Table 1 shows the reduction of sucrose in the model solution for the action of dextransucrase. The amount of sucrose reduced was converted to gluco-oligosaccharides and monosaccharides.

TABLE 1
Sucrose reduction in a model solution

| Treatment time | Sucrose |
|---|---|
| (hours) | (g/L) |
| 0 | 226 |
| 2 | 185 |
| 6 | 162 |
| 28 | 72 |

### Example 2

### Sugar Reduction in Orange Juice Concentrate by Using Dextransucrase

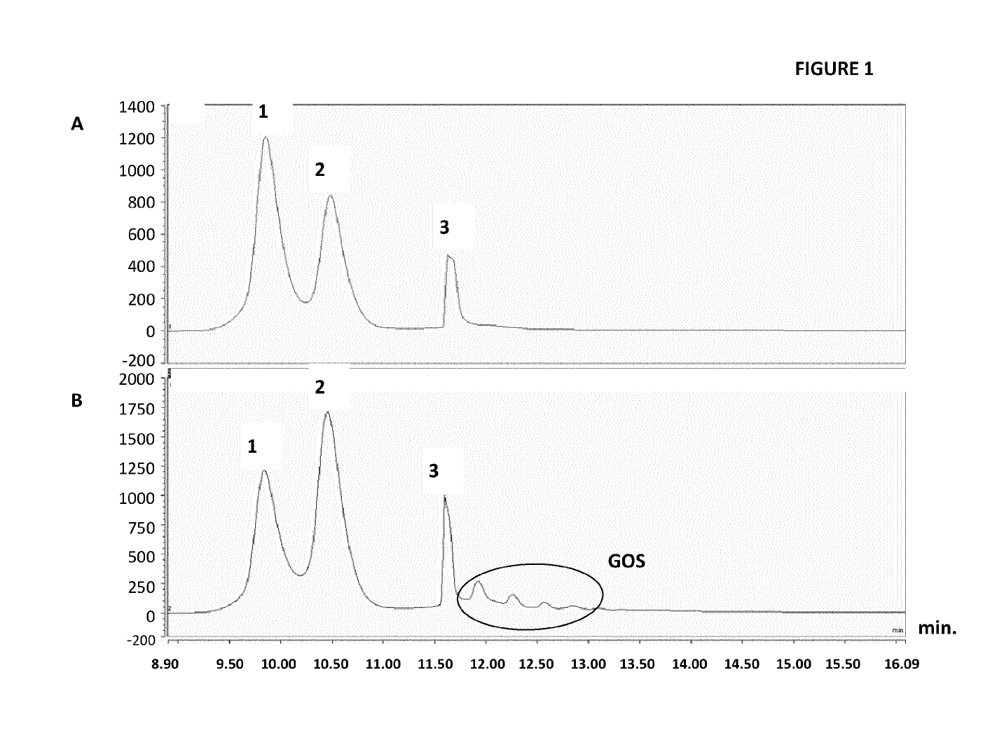

The in situ sugar reduction was studied in orange juice concentrate (OJC). The sugars present initially in OJC were sucrose, glucose and fructose. The OJC was treated with 0.036% (w/w) dextransucrase from Leuconostoc mesenteroides B-512F for 4 h. The reaction was carried out at 30° C. and the pH was adjusted to 5.2. Samples were drawn at appropriate time intervals and heated at 90° C. during 5-10 min to stop the enzyme activity. The sugar content of the samples was analyzed by a HPAEC Dionex system. This high performance anion exchange chromatography method used a cartridge column C18 coupled with pulse amperometric detector. The eluent was a gradient solution of NaOH. The chromatograms obtained show the formation of different types of oligosaccharides after treatment (FIG. 1B) when compared with the chromatograms obtained before treatment (FIG. 1A). The total sugar reduction was assessed by calculating the difference in sugar concentration (glucose, fructose and sucrose) between untreated OJC and the OJC treated with dextransucrase at different time intervals. The concentrations of glucose, fructose and sucrose were determined from peak areas by using standards. Table 2 shows the total sugar reduction for the action of dextransucrase. The amount of sugar reduced was converted to gluco-oligosaccharides (GOS).

TABLE 2
In situ sugar reduction in orange juice concentrate

| Treatment time | Total sugars |
|---|---|
| (hours) | (g/L) |
| 0 | 512 |
| 2 | 503 |
| 4 | 426 |

### Example 3

### Gluco-Oligosaccharides (GOS) Formation in Model Solution by Using Dextransucrase

The GOS formation was studied in model solution with similar sugar ratio and concentration of sugars present in orange juice concentrate. The reaction conditions were similar as the conditions in example 1. The sugar solution was treated with 0.014% (w/w) dextransucrase from Leuconostoc mesenteroides for 20 h. The reaction was carried out at 30° C. and the pH was adjusted to 5.2. Samples were drawn at appropriate time intervals and heated at 90° C. during 5-10 min to stop the enzyme activity. The sugar content of the samples was analyzed by HPLC. Table 3 shows the reduction of sucrose in the model solution for the action of dextransucrase. The amount of sucrose reduced was converted to gluco-oligosaccharides and monosaccharides. Even though different oligosaccharides peaks were observed in the chromatograms after the enzymatic reaction, due to the lack of GOS standards, the GOS content was calculated from the total sugar reduction. Microbial growth was monitored in the sugar solution during the reaction to ensure that the sugar reduction was not due to the microbial growth.

TABLE 3
Sugar content for GOS production in model solution

| Treatment time | DP1: | | GOS |
|---|---|---|---|
| (hours) | fructose + glucose (%) | Sucrose (%) | (%) |
| 0 | 54 | 46 | 0 |
| 3 | 60 | 37 | 2 |
| 20 | 66 | 18 | 16 |

### Example 4

### Fructo-Oligosaccharides (FOS) and Gluco-Oligosaccharides Formation in Model Solution

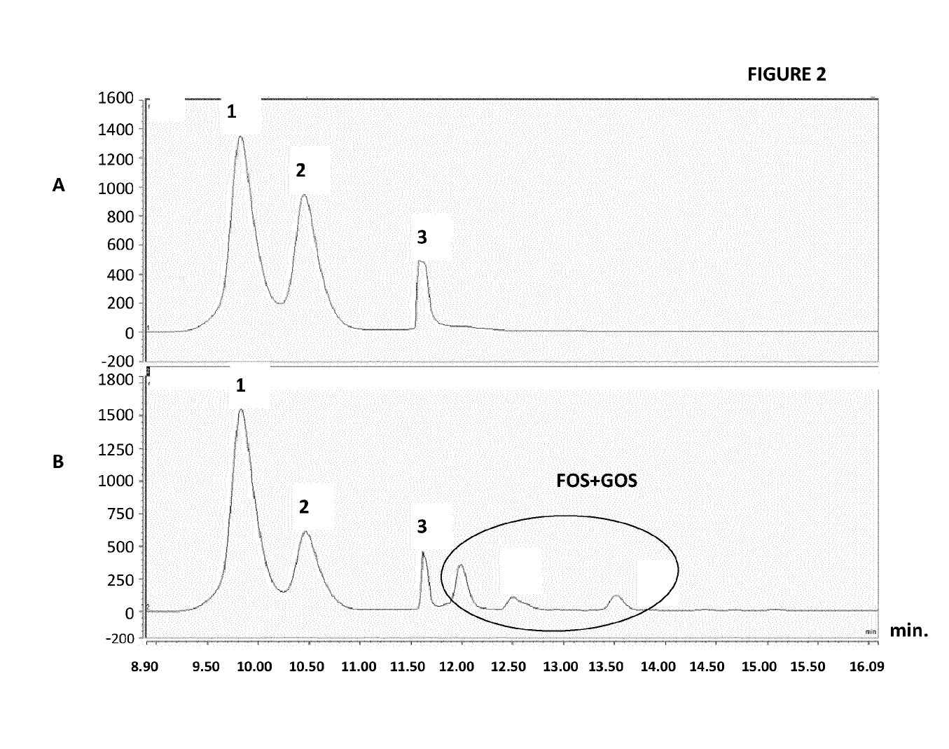

The sucrose reduction and oligosaccharides formation were studied in a model solution containing initially glucose and fructose and sucrose which are the main sugars present in most juices. The reaction was carried in two steps. The model solution was first treated with 8% (w/w) fructosyltransferase (Pectinex Ultra SP-L from Novozyme) at 50 C. Then the enzyme was deactivated. Afterwards, 0.036% (w/w) dextransucrase from Leuconostoc mesenteroides was added to the model solution at 30 C for a combined time of reaction of 6 h. At the end of the second reaction, dextransucrase was also deactivated. The pH was kept at 5.2 during both reactions. The enzyme fructosyltransferase was first applied to produce FOS with subsequent sucrose reduction and glucose formation. Then, the enzyme dextransucrase was applied to produce gluco-oligosaccharides, further reducing sucrose content. The sugar content of the samples was analyzed by using the same methodology as in example 2. However, in this case, FOS were calculated by using different standards and GOS were calculated again by mass balance. FIG. 2A shows a chromatogram for of the model solution before enzyme treatment. FIG. 2B shows a chromatogram of the solution after enzymatic treatment, where FOS and GOS peaks appear, showing the formation of these compounds.

Table 4 shows that by using both fructosyltransferase and dextransucrase, the total sucrose content, can be reduced to the lowest caloric level, and the highest level of oligosaccharides is produced, as compared to using either enzyme alone.

TABLE 4
Sucrose reduction and NDOs production in model solution

| | Treatment | Mono- | | |
|---|---|---|---|---|
| | time | saccharides | Sucrose | FOS + GOS |
| | (hours) | (%) | (%) | (%) |
| Model solution | 0 | 69 | 31 | 0 |
| Model solution treated | 6 | 56 | 15 | 29 |
| with β-fructosyl- | | | | |
| tranferase and | | | | |
| dextransucrase | | | | |

### Example 5

### Fructo-Oligosaccharides (FOS) and Gluco-Oligosaccharides Formation in a Orange Juice Concentrate

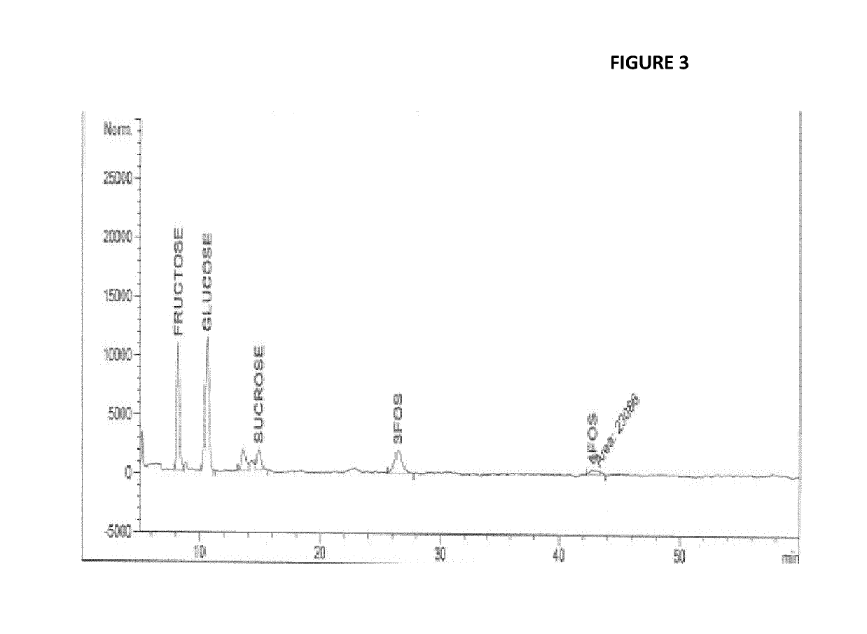

The sucrose reduction and oligosaccharides formation were studied in samples of orange juice concentrate (OJC). The reaction was carried out in two steps with the same conditions as in example 4. The juice concentrate was treated with 8% (w/w) fructosyltransferase and then with 0.014% (w/w) dextransucrase from Leuconostoc mesenteroides for 24 h. The enzyme fructosyltransferase was first applied to produce FOS with subsequent sucrose reduction and glucose formation in juice. Then, the enzyme dextransucrase was applied to produce gluco-oligosaccharides, further reducing sucrose content. The glucose, fructose, sucrose and FOS content was analyzed by HPLC with a pump (Agilent 1100 Series) coupled to a carbohydrate column (Shodex amino column Ashipak NH2P-50 4E). A refractive index detector was used. The mobile phase was 75% (v/v) acetonitrile. The concentration of all these sugars was determined from peak areas by using standards. FIG. 3 shows a chromatogram for the formation of FOS. The GOS concentration was calculated from mass balance difference between the OJC before and after the enzymatic treatment with dextransucase since no GOS was able to be detected with this methodology. Table 5 shows that by using both fructosyltransferase and dextransucrase, the total sucrose content, can be reduced to the lowest caloric level, and the highest level of oligosaccharides, as compared to the corresponding food product or using either enzyme alone.

TABLE 5
Sucrose reduction and NDOs production in OJC.

| | Treatment | mono- | | |
|---|---|---|---|---|
| | time | saccharides | sucrose | FOS + GOS |
| | (hours) | (%) | (%) | (%) |
| orange juice concentrate | 0 | 52.1 | 47.9 | 0.0 |
| OJC treated with | 2 | 61.8 | 15.5 | 22.6 |
| fructosyltransferase | | | | (only FOS) |
| OJC treated with | 24 | 65 | 5 | 30 |
| fructosyltransferase + | | | | |
| dextransucrase | | | | |

1. A method of reducing intrinsic sugar content of a food product comprising contacting the food product with a sufficient amount of at least one transglycosidase under conditions sufficient to enzymatically convert intrinsic sugars in the food product to non-digestible oligosaccharides, thus reducing intrinsic sugar content of the food product and forming a more nutritional food product.

2. The method of claim 1, wherein the at least one transglycosidase is a glucosyltransferase.

3. The method of claim 2, comprising further reducing the intrinsic sugar content of the food product by contacting the food product with a sufficient amount of a fructosyltransferase under conditions sufficient to enzymatically convert further intrinsic sugars in the food product to non-digestible oligosaccharides.

4. The method of claim 3, wherein the fructosyltransferase and the glucosyltransferase simultaneously contact the food product.

5. The method of claim 3, wherein the fructosyltransferase and the glucosyltransferase sequentially contact the food product by:
forming a reduced sucrose food product by first contacting the food product with a sufficient amount of the fructosyltransferase under conditions sufficient to enzymatically convert at least some of the intrinsic sugars in the food product to non-digestible fructo-oligosaccharides while also forming glucose; and
then contacting the reduced sucrose food product with a sufficient amount of the glucosyltransferase under conditions sufficient to enzymatically produce gluco-oligosaccharides while reducing glucose and further reducing sucrose therein, thus reducing the intrinsic sugar content of the resulting food product.

6. The method of claim 3, wherein the fructosyltransferase and the glucosyltransferase sequentially contact the food product by:
forming a reduced sucrose food product by first contacting with a sufficient amount of the glucosyltransferase under conditions sufficient to enzymatically convert at least some of the intrinsic sugars in the food product to gluco-oligosaccharides while reducing glucose and sucrose therein; and
then contacting the reduced sucrose food product with a sufficient amount of the fructosyltransferase under conditions sufficient to enzymatically convert at least some of the intrinsic sugars in the food product to non-digestible fructo-oligosaccharides while also forming glucose, thus reducing the intrinsic sugar content of the resulting food product.

7. The method of claim 5, comprising terminating the first enzymatic reaction by applying heat or conducting pasteurization before contacting the food product with the second enzyme.

8. The method of claim 7, which further comprises terminating the second enzymatic reaction after the nutritional food product is obtained.

9. The method of claim 1, comprising immobilizing the enzymes on a support prior to the contacting steps such that the enzymatic reaction can be terminated by removing the immobilized enzymes from contact with the food product.

10. The method of claim 2, wherein the glucosyltransferase is a dextransucrase.

11. The method of claim 10, wherein the dextransucrase is derived from a strain of lactic bacteria.

12. The method of claim 11, wherein the strain of lactic bacteria is selected from the group consisting of Leuconostoc mesenteroides, Leuconostoc citreum, Streptococcus mutans, and Lactobacillus.

13. The method of claim 3, wherein the fructosyltransferase is derived from a plant or microbial source.

14. The method of claim 1 comprising contacting the food product with a levansucrase to produce non-digestible carbohydrates in the food product.

15. The method of claim 1, wherein the food product is a juice or a ready to drink product that contains sugars.

16. The method of claim 15, wherein the sucrose content of the juice or ready to drink product is reduced by at least 10% after exposure to dextransucrase as compared to a corresponding juice or ready to drink product which is not subjected to such exposure.

17. The method of claim 15, wherein the sucrose content of the juice or ready to drink product is reduced by at least 30% after exposure to fructosyltransferase and dextransucrase as compared to a corresponding juice or ready to drink product which is not subjected to such exposure.

18. The method of claim 17, wherein the sugar conversion to non-digestible oligosaccharides is at least 10% after exposure to fructosyltransferase and dextransucrase as compared to a corresponding juice or ready to drink product which is not subjected to such exposure.

19. A nutritional food product produced by the method of claim 1.

20. The nutritional food product of claim 19, wherein the food product is a fruit juice or a ready to drink product.

21. The nutritional food product of claim 20, wherein the fruit juice is selected from the group consisting of orange juice, peach juice and mango juice.

22. The nutritional food product of claim 19, wherein the food product contains at least 10% non-digestible oligosaccharides based on the dry weight of the food product after exposure to fructosyltransferase and dextransucrase.

23. A method comprising using fructosyltransferase and glucosyltransferase either simultaneously or sequentially to enzymatically convert intrinsic sugars in a food product to non-digestible oligosaccharides to reduce the intrinsic sugar content of the food product and form a more nutritional food product.
